(19) United States
(12) Patent Application Publication
(10) Pub. No.: US 2007/0126799 A1
(43) Pub. Date: Jun. 7, 2007

(54) Apparatus and method for synchronously stimulating a plurality of fluid jets

(75) Inventor: Thomas W. Steiner, Burnaby (CA)

Correspondence Address: Mark G. Bocchetti, Patent Legal Staff;Eastman Kodak Company, 343 State Street, Rochester, NY, 14650-2201, US

(73) Assignee: Eastman Kodak Company

(21) Appl. No.: 11/292,761

(22) Filed: Dec. 1, 2005

(51) Int. Cl. B41J 2/06

(52) U.S. Cl. 347/55; 347/82

(57) ABSTRACT

A common electrohydrodynamic stimulation electrode, in response to an electrical signal, synchronously stimulates all members of a group of fluid jets emitted from corresponding nozzle channels to form a corresponding plurality of continuous streams of drops. The common electrohydrodynamic stimulation electrode includes an electrical contact operable to transmit the electrical signal to each member of the nozzle channels via a contiguous electrically conductive portion. The contiguous electrically conductive portion forms a permanently electrically conductive path between and forms a portion of each nozzle channel. Synchronous stimulation of each of the fluid jets facilitates accurate phase locking of print data dependent charging of the drop streams.

### FIELD OF THE INVENTION

The invention pertains to the field of ink jetting fluids and, in particular to simultaneously stimulating a plurality of fluid jets to form a corresponding plurality of streams of drops.

### BACKGROUND OF THE INVENTION

The use of ink jet printers for printing information on a recording medium is well established. Printers employed for this purpose may be grouped into those that emit a continuous stream of fluid drops, and those that emit drops only when corresponding information is to be printed. The former group is generally known as continuous inkjet printers (CIJ) and the latter as drop-on-demand inkjet printers. The general principles of operation of both of these groups of printers are very well recorded. Drop-on-demand inkjet printers have become the predominant type of printer for use in home computing systems, whereas continuous inkjet systems find major application in industrial and professional environments.

Continuous inkjet systems may produce higher quality images at higher speeds than drop-on-demand systems. Continuous inkjet systems typically have a print head that incorporates a fluid supply and a nozzle plate with one or more nozzle orifices fed by the fluid supply. The fluid is jetted through the nozzle plate to form one or more thread-like streams of fluid from which corresponding streams of drops are formed. Within each of the streams of drops, some drops are selected to be printed on a recording surface, while other drops are selected not to be printed, and are consequently guttered. A gutter assembly is usually positioned downstream from the nozzle plate in the flight path of the drops to be guttered.

In order to create the stream of drops, a drop generator is associated with the print head. The drop generator stimulates the stream of fluid within and just beyond the print head, by a variety of mechanisms discussed in the art. This is done at a frequency that forces continuous streams of fluid to be broken up into a series of fluid drops at a specific break-off point within the vicinity of the nozzle plate. In the simplest case, this stimulation is carried out at a fixed frequency that is calculated to be optimal for the particular fluid, and which matches the characteristic frequency of the fluid jet ejected from the nozzle exit orifice. A distance between successively formed drops, S, is typically related to the jet velocity, v, and the stimulation frequency, f by the relationship: v=fS.

FIG. 1 shows a conventional continuous ink jet print head employing an electrohydrodynamic (EHD) drop stimulation electrode 13 to excite a continuous jet of fluid into a stream of drops. Fluid supply 10 contains fluid 12 under pressure which forces fluid 12 through nozzle channel 20 in the form of a jet 22. Fluid 12 is typically conductive in nature. Fluid 12 is grounded or otherwise connected through an electrical pathway. Conventional drop stimulation electrode 13 is typically annular in form and is typically positioned concentric with the nozzle channel 20 shown in cross-section in FIG. 1A.

Referring back to FIG. 1, drop stimulation electrode 13 is electrically connected to a stimulation signal driver 17 that produces a waveform of chosen voltage amplitude, period and functional relationship with respect to time in accordance to a stimulation signal 19. In FIG. 1 an example of a stimulation signal 19 comprises a uni-polar square wave with a 50% duty cycle. The EHD stimulation is a function of the field strength squared at the surface of fluid 12 near the exit orifice 21 of nozzle channel 20 that induces charge in jet 22 and creates pressure variations along the jet. Drop stimulation electrode 13 is typically covered by one or more insulating layers 24 which are necessary to isolate the drop stimulation electrode 13 from fluid 12 in order to prevent field collapse, excessive current draw and resistive heating of conductive fluid 12. Additionally, insulating layers 24 may protect drop stimulation electrode 13 from any corrosive effects of fluid 12. Fluid 12 should be sufficiently conductive enough to allow charge to move through the fluid from the grounded fluid supply 10 in order to have effective electrohydrodynamic stimulation of the drops that subsequently form at break-off point 26.

FIG. 1 also shows a typical conventional drop characterizing means comprising a charging electrode 30. One or more drop deflection plates 38 may be used to separate the characterized drops. Typically, conventional inkjet print heads that employ electrostatic drop characterizing means employ fluid 12 conductivities on the order of 5 mS/cm. These conductivity levels permit induction of sufficient charge on charged drops 34 to allow downstream electrostatic deflection. The conductivity required for drop charging is typically much greater than that for drop stimulation. Thus, a conductive fluid that is suitable for charging can also be stimulated using EHD. The selective charging of the drops in conventional inkjet systems allows each drop to be characterized. That is, the conductive fluids permit charges of varying levels and sometimes, polarities to be selectively induced on the drops such that they may be characterized for different purposes. Such purposes may include selectively characterizing each of the drops to be used for printing, or to not be used for printing.

Since fluid 12 typically includes conductive properties required for the inductive charging of drops, a non-uniform distribution of charge cannot be supported in the fluid jet 22 outside of the stimulating electric field. The entire EHD stimulation effect occurs due to the momentary induction of charge in fluid 12 at exit orifice 21 that creates the pressure variation in jet 22. For a correctly chosen frequency of the stimulation signal 19, the perturbation arising from the pressure variations will grow on the conductive fluid jet 22 until break off occurs at the break-off point 26.

In accordance with a charging signal 33, charging electrode driver 32 produces a time varying potential. Charging electrode 30 is connected to charging electrode driver 32, and is driven by the time varying potential. The potential attracts charge through fluid 12 to the end of fluid jet 22 where it becomes locked-in or captured by charged drops 34 once they break-off from the jet 22.

The potential waveform produced by the charging electrode driver 32 will determine how the formed drops will be characterized. The voltage waveform will typically determine which of the formed drops will be selected for printing and which of the formed drops will not be selected for printing. Drops in this example are characterized by charging as shown by charged drops 34 and uncharged drops 36. Since a specific drop characterization is dependent upon whether that drop is printed or not, the voltage waveform will typically be based at least in part on a print-data stream provided by one or more systems controllers (not shown). The print-data stream typically includes information or instructions as to which of the specific drops within the stream of drops are to be printed with, or not printed with. The potential waveform will therefore vary in accordance with the image content of the specific image to be reproduced. Additionally, the potential waveform may be also based at least in part, by methods or schemes employed to improve various printing quality aspects such as the placement accuracy of drops selected to be printed with. Guard drop schemes are an example of these methods. Guard drop schemes typically define a regular repeating pattern of drops within the stream of drops. Drops within the regular repeating pattern that can be selected to print with if required by the print-data stream are referred to as “print-selectable” drops. The pattern is additionally arranged such that additional drops separate the print-selectable drops. These additional drops cannot be printed with regardless of the print-data stream and are referred to as “non-print selectable” drops. Guard drop schemes are employed to minimize unwanted electrostatic field effects between the successive print-selectable drops and thus improve the placement accuracy of the print-selectable drops that are selected for printing based on the print data stream. These guard drop schemes may be programmed into one or more systems controllers and will therefore typically alter the potential waveform so as to define the print-selectable drops. The potential waveform will therefore typically characterize printing drops from non-printing drops by selectively charging individual drops within the stream of drops in accordance with the print data stream and any guard drop scheme that is employed.

Electrostatic deflection plates 38 placed near the trajectory of the characterized drops interact with charged drops 34 by steering them according to the drop charge and the electric field between the plates. In the conventional example shown in FIG. 1, charged drops 34 deflected by deflection plates 38 may be collected on gutter 40 while uncharged drops 36 may pass through substantially un-deflected and are deposited on a recording surface 42. In other conventional systems, this situation may be reversed with the deflected charged drops being deposited on the recording surface 42. In either case, further complications arise from the fact that the charging electrode driver 32 must be synchronized with stimulation signal driver 17 to ensure that optimum charge levels are transferred to drops, thus ensuring accurate drop printing or guttering as the architecture of the recorder may dictate. Failure to synchronize may result in partially charged drops that may deposit at incorrect positions on the recording surface 42 or gutter 40 which in turn, may adversely impact print quality and print-head reliability. This synchronization problem is additionally compounded when the print head includes multiple jets, each of which must be stimulated and charged in a synchronized manner. (Synchronizing the drops formed by multiple jets with subsequently applied charging pulses is referred to as phase locking the print-data dependent charging.) Further, synchronization is even more difficult in high-resolution (i.e. 500 dpi or greater) electrostatic continuous inkjet systems that require a large number of densely packed continuous streams of very small drops to be formed.

Accordingly, there is a need for an improved way to synchronously stimulate all members of a plurality of fluid jets. Such synchronous stimulation needs to provide sufficient uniformity to ensure substantially uniform drop break-off among the plurality of the jets, even at high resolution. Further, a need exists for such synchronous stimulation not only to ensure accurate phase locking with any subsequently employed charge-based drop characterization scheme, but to also provide additional aspects that are required for high quality printing. Such aspects may include drop volume uniformity and velocity uniformity.

### SUMMARY OF THE INVENTION

The above-described problems are addressed and a technical solution is achieved in the art by an apparatus and a method for synchronously stimulating a plurality of fluid jets according to the present invention. In an embodiment of the present invention a common electrohydrodynamic stimulation electrode is provided to synchronously stimulate all members of a plurality of conductive fluid jets to form a corresponding plurality of drop streams; The common electrohydrodynamic stimulation electrode includes a contiguous electrically conductive portion that forms at least a portion of each member of a plurality of nozzle channels, from which the fluid jets are emitted. The common electrohydrodynamic stimulation electrode also includes an electrical contact operable to transmit a common electrical signal to each member of the plurality of nozzle channels via the contiguous electrically conductive portion. By stimulating the plurality of nozzle channels with the common electrical signal, synchronous stimulation of the plurality of fluid jets is facilitated, even at high resolution, while ensuring accurate phase locking with any subsequently employed charge-based drop characterization scheme. Further, the electrical contact operable to transmit the common electrical signal to each of the plurality of nozzle channels provides a simple design for providing the synchronous stimulation.

According to a further embodiment of the present invention, the electrical contact includes a conductive annulus positioned around the plurality of nozzle channels. According to another embodiment of the present invention, the plurality of nozzle channels are arranged in one or more rows, and the electrical contact includes a conductive member located at an end of the one or more rows. Such configurations, although not required, improve the ability to synchronously stimulate the plurality of fluid jets.

According to still another embodiment of the present invention, a reservoir is provided that is operable to supply conductive fluid to the plurality of nozzle channels. Also provided is a fixed potential layer structure located on at least one surface of the reservoir. The fixed potential layer structure is electrically conductive and is operable to hold the conductive fluid at a fixed potential. According to yet another embodiment of the present invention, at least one electrically insulating portion is provided that is disposed on a surface of the contiguous electrically conductive portion. Also provided is a shield portion disposed on a surface of the at least one electrically insulating portion. The shield portion includes a conductive material a plurality of openings. Each of the plurality of openings corresponds to one or more members of the plurality of nozzle channels. Such arrangements reduce undesired effects of inductive A/B charging, discussed in detail below.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 shows a conventional inkjet recording apparatus that employs electrostatic charging and deflection means;

FIG. 1A shows a cross-sectional view of a conventional drop stimulation electrode;

FIG. 2 shows a printing apparatus, according to an embodiment of the present invention;

FIG. 3 shows a partial cross-section view of a print head, according to an embodiment of the present invention;

FIG. 4 shows a full cross-sectional view of the print head shown in FIG. 3,

FIG. 5 shows a partial sectional view of print head including a conductive ring electrical contact, according to an embodiment of the present invention;

FIG. 5A shows a simplified model of the conductive ring embodiment of the present invention shown in FIG. 5;

FIG. 6 shows a partial sectional view of a print head including varying electrical contact-to-nozzle distances, according to an embodiment of the present invention;

FIG. 7A shows a cross-sectional view of a SOI wafer suitable for the construction of a print head, according to an embodiment of the present invention;

FIG. 7B shows a reservoir and plurality of nozzles channels formed in the SOI wafer shown in FIG. 7A, according to an embodiment of the present invention;

FIG. 7C shows the print head produced from the SOI wafer shown in FIG. 7A, according to an embodiment of the present invention;

FIG. 8 shows a graph that simulates the changes in the radial electrohydrodynamic impulse ratio (P_{EHD}/P₀) as a function of the width of a portion of an area of a common stimulation electrode surrounding a given orifice;

FIG. 9 shows a plan view of a print head surface that is substantially covered with a grounded shield layer structure, according to an embodiment of the present invention;

FIG. 10 shows a plan view of a print head that includes two separate common electrohydrodynamic electrodes separated by a p/n junction, according to an embodiment of the present invention;

FIG. 11 shows a plan view of a print head that includes two separate common electrohydrodynamic electrodes separated by a trench, according to an embodiment of the present invention;

FIG. 12 shows a cross-sectional view of a print head in which a ground layer structure covers a surface of a reservoir of the print head, according to an embodiment of the present invention; and

FIG. 13 shows a cross-sectional view of a print head that includes a grounded conductive layer and an insulator layer, according to an embodiment of the present invention.

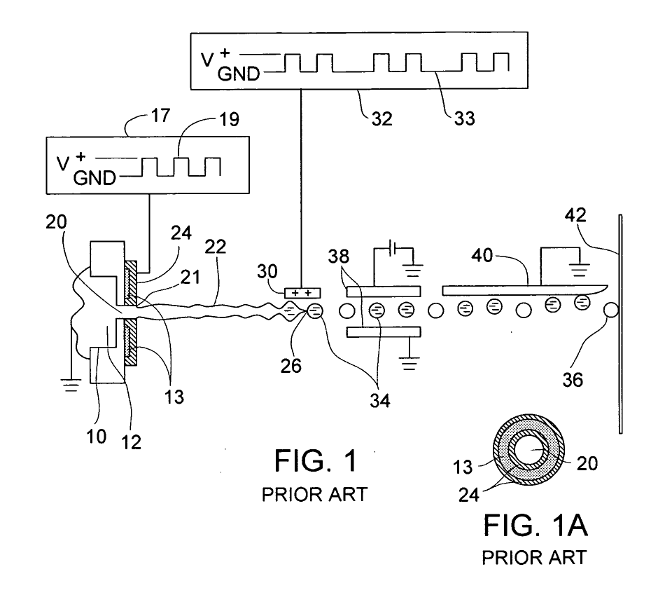

It is to be understood that the attached drawings are for purposes of illustrating the concepts of the invention and may not be to scale.

### DETAILED DESCRIPTION OF THE INVENTION

Throughout the following description specific details are presented to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

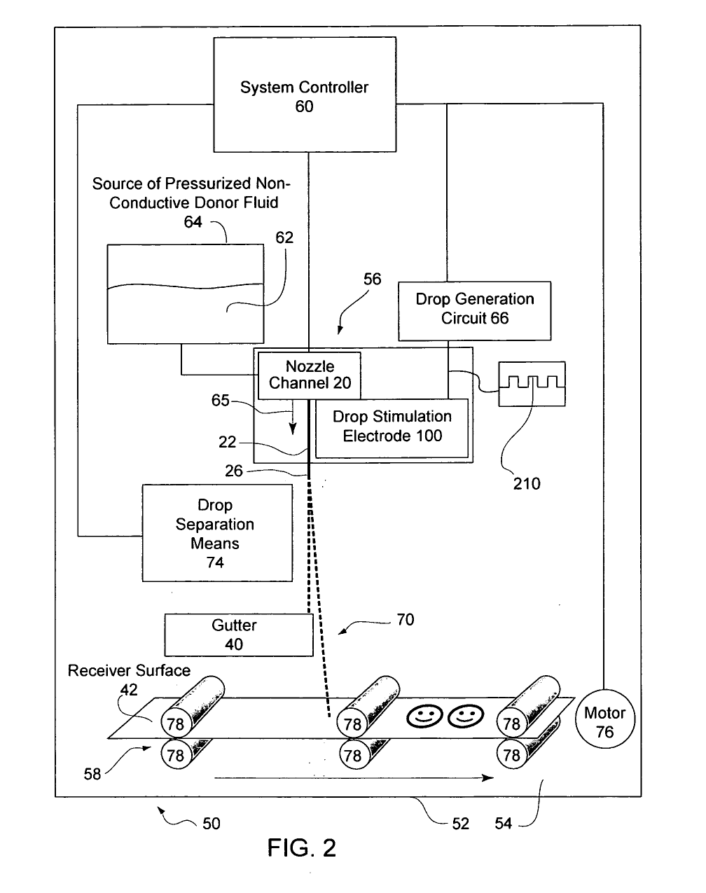

FIG. 2 schematically shows a printing apparatus 50, according to an embodiment of the present invention. Printing apparatus 50 includes a housing 52 that can include any of a box, closed frame, continuous surface or any other enclosure defining an interior chamber 54. In the embodiment of FIG. 2, interior chamber. 54 of housing 52 holds an inkjet print-head 56, a translation unit 58 that positions a receiver surface 42 relative to inkjet print-head 56, and system controller 60. System controller 60 may include a micro-computer, micro-processor, micro-controller or any other known arrangement of electrical, electro-mechanical and electro-optical circuits and systems that can reliably transmit signals to inkjet print head 56 and translation unit 58 to allow the pattern-wise disposition of donor fluid 62 onto receiver surface 42. Systems controller 60 may include a single controller or it may include a plurality of controllers.

As is illustrated in FIG. 2, inkjet print head 56 includes a source of pressurized donor fluid 64 such as a pressurized reservoir or a pump arrangement and a nozzle channel 20 allowing the pressurized donor fluid 62 to form a jet 22 traveling in a first direction 65 toward receiver surface 42. In response to a drop stimulation signal 210, common electrohydrodynamic drop stimulation electrode 100 applies a force to each of a plurality of fluid jets 22 to perturb the fluid jets 22 to form corresponding streams of drops 70 at respective break-off points 26. For the sake of clarity only one fluid jet 22 and corresponding nozzle channel 20 is shown in FIG.2. Discrete or integrated components within drop generation circuit 66 such as timing circuits of a type well known to those of skill in the art may be used or adapted for use in generating the droplet stimulation signal 210 to form drops.

Selected drops within the stream of drops 70 may be characterized to be printed with or not to be printed. A drop separation means 74 is used to separate drops selected for printing from the other drops based on this characterization. Drop separation means 74 may include any suitable means that can separate the drops based on the characterization scheme that is employed. Without limitation, drop separation means 74 can include one or more electrostatic deflection plates operable to apply an electrostatic force to separate droplets within the stream of drops 70 when the characterization scheme involves a selective charging of droplets. As shown in FIG. 2, drop separation means 74 is employed to deposit drops comprising a first characteristic onto receiver surface 42 while other drops comprising a second characteristic are deposited to gutter 40.

In the embodiments of the present invention to follow, an apparatus and method will be described for synchronously stimulating all members of a plurality of fluid jets 22 in inkjet print head 56. It will be understood that donor fluid 62 is not limited thereby to an ink and may comprise any fluid that can form a jet as described herein in the embodiments of the present invention. Typically, donor fluid 62 will carry a colorant, ink, dye, or other image forming material. However, donor fluid 62 can also carry electrically conductive material, dielectric material, electrically insulating material, magnetic material, optically conductive material or other functional material.

Further, in the embodiment illustrated in FIG. 2, receiver surface 42 is shown as comprising a generally paper type receiver medium, however, the invention is not so limited and receiver surface 42 may comprise any number of shapes and forms and may be made of any type of material upon which a pattern of donor fluid 62 may be imparted in a coherent manner.

Accordingly, in the embodiment illustrated in FIG. 2, translation unit 58 has been shown as having a motor 76 and arrangement of rollers 78 that selectively positions a paper type receiver surface 42 relative to a stationary inkjet print head 56. This too is done for convenience and it will be appreciated, that receiver surface 42 may comprise any type of receiver surface 42 and translation unit 58 will be adapted to position either one of the receiver surface 42 and inkjet print head 56 relative to each other.

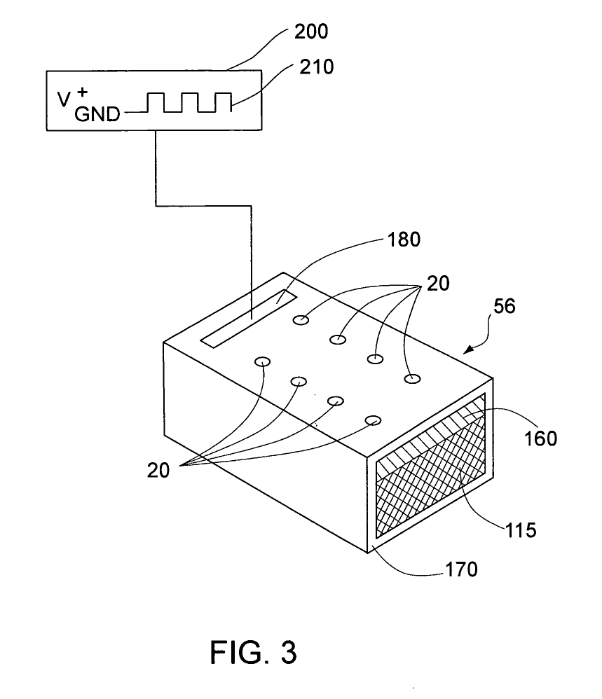

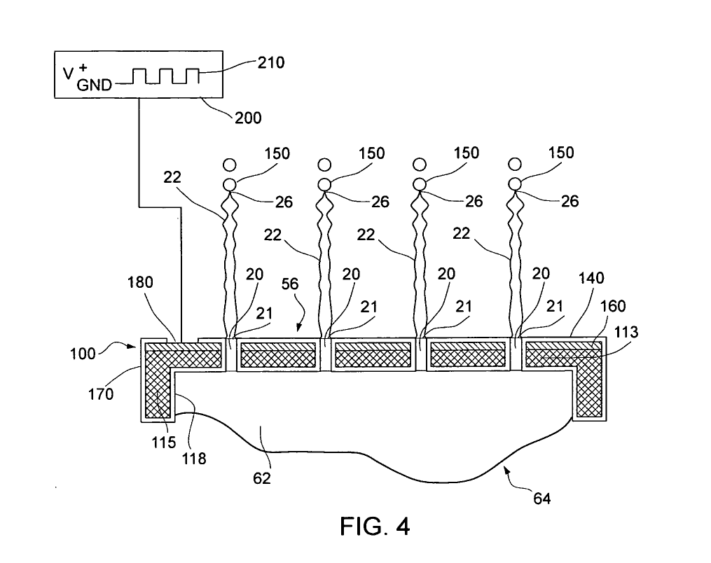

FIGS. 3 and 4 show a print head 56, according to an embodiment of the present invention. Print head 56 includes a source of pressurized donor fluid 64 such as reservoir 118 and a plurality of nozzle channels 20. In this example embodiment of the invention, the plurality of nozzle channels 20 is made up of two rows of nozzle channels 20 that are formed in nozzle plate 113. In this example embodiment of the invention a portion of the nozzle-to-nozzle spacing in each row staggers each of the two rows of nozzle channels 20 from one another. Other embodiments of the present invention may include multi-jet arrangements including a single group or row of nozzles channels. Further embodiments of the present invention may include more than two groups of nozzle channels, or more than two rows of staggered or un-staggered nozzle channels. Further, it is to be understood that the plurality of nozzle channels 20 may include any suitable number of nozzle channels that are within the scope of the present invention. Nozzle channels 20 are used to form and emit corresponding continuous jets 22 from donor fluid 62. Source of pressurized donor fluid 64 contains and supplies donor fluid 62 to nozzle channels 20. Source of pressurized donor fluid 64 may include, but is not limited to reservoir 118. Donor fluid 62 is typically conductive in nature and is grounded while being contained in reservoir 118. In this embodiment of the invention, reservoir 118 is shown as an open reservoir for the purposes of clarity only. Reservoir 118 can include a closed reservoir with optional additional fluid inlets and/or fluid outlets. As shown In FIG. 4, reservoir 118, supplies donor fluid 62 to all the plurality of nozzle channels 20. In some embodiments of the invention, a separate source of pressurized donor fluid 64 can supply one or more nozzle channels within the plurality of nozzle channels 20. Reservoir 118 can be produced from one or more components. Reservoir 118 can be formed from print-head substrate 115. Nozzle plate 113 that includes the plurality of nozzle channels 20 can be additionally formed in substrate 115.

In order to generate streams of identical drops from each fluid jet 22, each jet 22 needs to be stimulated near its characteristic frequency. A characteristic frequency is a frequency associated with the maximum instability of a fluid jet that results in the jet breaking up into a plurality of drops. The characteristic frequency can be defined by the relationship f_{c}=v/λ_{c}, wherein:
f_{c} is a characteristic frequency of the jet,
v is a jet velocity, and
λ_{c} is a characteristic drop-to-drop spacing.

The variable λ_{c} can be expressed by the relationship: λ_{c}=4.51 dⱼ, where dⱼ is an effective jet diameter. The effective jet diameter can be different from an exit orifice 21 diameter of an associated nozzle channel 20, since the fluid jet 22 may contract after leaving the exit orifice 21. The effective jet diameter is typically the jet diameter at the jet's initial contracted point. An initial suitably sized perturbation initiated at nozzle channel exit orifice 21 will grow exponentially until it reaches the size of the jet radius at which point a drop 150 breaks off from jet 22. A non-limiting example of a suitably sized perturbation may include a perturbation a thousand times greater than the natural random fluctuation of a non-externally perturbed jet. The time it takes from the initial perturbation to a break-off point 26 where drop 150 breaks off depends on the initial jet radius as well as the strength of the initial perturbation. This time may also depend on the fluid properties of donor fluid 62 including surface tension and viscosity, but since the same donor fluid 62 is typically fed to all the nozzle channels 20, the fluid properties do not contribute to any significant jet-to-jet variations. In order to have the drops 150 break-off at the same time across all the fluid jets 22 of the array, it is required that the exit orifices 21 of the nozzle channels 20 be substantially uniform, and that the stimulating perturbations include substantially the same amplitude and phase, and be applied at the same point along the length of each fluid jet 22.

Nozzle channels 20 may be produced by a method that produces substantially uniform nozzle channels across the print head array irrespective of the number of nozzle channels that make up the array. According to an embodiment of the present invention, the areas defined by each of the exit orifices 21 are substantially equal to one another. Some variance in the shape of each nozzle channel is permitted as it extends upstream from print-head surface 140 to reservoir 118. This variance should preferably be consistent from nozzle-to-nozzle to ensure that substantially equal flow conditions exist across all of the jets. Accordingly, a manufacturing method that can produce nozzle channels with substantially equal exit orifice areas and minimal size and shape variances along the lengths of each nozzle channel is preferred. Although not required, an axial length of each nozzle channel 22 should be substantially equal across the array especially when the flow established within the nozzle channels is not fully developed. High-resolution print heads may further require uniform nozzle channels with the added restrictions of small diameters (approximately 10 microns or less) and with high length-to-diameter aspect ratios.

Some micro-machining techniques are well suited for producing nozzle channels 20 under these constraints, especially when the print head substrate 115 is produced from Silicon (Si) or other suitable substrate material. In particular, in an embodiment of the invention, deep reactive ion etching (DRIE) is employed to produce nozzle channels 20, each with exit orifice 21 areas that are identical to one another within about ±0.5%. DRIE, which is sometimes referred to as Bosch etching, relies on alternating cycles of ion-assisted etching and polymer deposition to create bores or trenches with substantially parallel side-walls. Masking layers made from photo resist or silicon dioxide (SiO₂) may be used with the DRIE process. DRIE is desirable because a tight dimensional control of a given feature size may be maintained.

By producing a plurality of nozzle channels 20 with corresponding nozzle exit orifice 21 areas that are identical to each other within about ±0.5%, drops 150 will typically be formed from each of the corresponding fluid jets 22 with a break-off uniformity of about ±0.1 drop wavelengths, λ when a uniform stimulation perturbance is applied across all the jets 22. Drop wavelength, λ is typically equal to a center-to-center distance between successively formed droplets. A break-off uniformity level that typically allows substantially synchronous charging of all the drops in an array has been experimentally determined to be about ±0.15 drop wavelengths, λ (i.e. a total window of approximately λ/3).

Satellite drops (not shown in FIG. 4) are typically smaller drops that form from fluid ligaments (also not shown) emanating from main drops 150 at break-off. The formation of satellite drops is not unique to electrohydrodynamic stimulation. Satellite drops may be classified according to whether they merge with a main drop formed ahead of the satellite or with a main drop formed behind the satellite drop. Satellite drops may be classified as “good merging” when a main drop and corresponding ligament break off as a unit during the formation of a satellite such that the combined charge of the main drop and satellite drop is fixed. Satellite drops may be classified as “bad merging” if a main drop, and the satellite drop that will ultimately merge with it, break off from the jet at different times and may hence be charged to different states. “Bad merging” satellite formation is typically more prevalent than “good merging” satellite formation. Typically, approximately a λ/2 window exists between drop break-off and satellite break-off. Since a typical stimulation signal driver time constant and a typical single jetted fluid RC time constant may collectively add up to approximately λ/6. (at approximately 650 kHz), the λ/2 window may be decreased to approximately λ/3 (i.e. λ/2-λ/6). Even if the driver was infinitely fast and the jetted fluid extremely conductive, one may still be limited to a window of λ/2 unless the satellite formation can be suppressed or satellite formation can be constrained to be of the “good merging” type.

Stimulating the jets within a λ/3 window may leave little room for variation in the stimulation level even when the nozzle channels have been produced with exit orifice 21 area variances in the order of about ±1%. Nozzle exit orifice 21 areas should be produced with variances within about ±0.5%. To further minimize variances in the exit orifices 21 areas, the fabrication method used to produce nozzle channels 20 may be referenced from surface 140.

It is to be noted that the DRIE process is one example of a method that is suitable for producing the plurality of nozzle channels 20. Other embodiments of the present invention can use any appropriate fabrication technique known in the art that is capable of producing the plurality of nozzle channels 20 to the necessary tolerances from any suitable substrate.

Referring back to FIGS. 3 and 4, print head 56 is produced from substrate 115 that is made from silicon or other suitable material. Silicon is a very good structural material in which nozzle channels 20 can be formed with the necessary tolerances. Common electrohydrodynamic (“EHD”) stimulation electrode 100 includes a contiguous electrically conductive portion 160. Provided substrate 115 is chosen to have a sufficiently high conductivity, substrate 115 may itself form the common EHD drop stimulation electrode 100. Print head substrate 115 may be inherently conductive, or such as in the case of silicon, may be made conductive by selectively or completely doping the substrate by various semiconductor fabrication processes known in the art. As shown in FIG. 4, substrate 115 includes a contiguous electrically conductive layer structure 160 formed at printhead surface 140. In this embodiment of the invention, contiguous conductive layer structure 160 is formed by doping substrate 115. Referring to FIG.4, nozzle plate 113, which includes the plurality of nozzle channels 20, is formed from substrate 115. Contiguous conductive layer structure 160 forms a portion of each of the nozzle channels 20. Contiguous conductive layer structure 160 is formed such that each of the plurality nozzle channels 20 is directly electrically interconnected to each other by contiguous conductive layer structure 160.

Contiguous conductive layer structure 160 may form a permanently electrically conductive path (e.g., a conductive path not subject to being switched off as by a transistor) between a first member of the nozzle channels and every other member of the nozzle channels to reduce design complexity. In other words, the permanently electrically conductive path need not vary in conductivity substantially with time or under the influence of various input electrical signals to print head 56 including any potential waveforms associated with drop stimulation signal 210. In some embodiments of the present invention, contiguous conductive layer structure 160 may include one or more conductive layers, or may include a portion or all of a conductive region of substrate 115, so long as the conductive region is contiguous. Contiguous conductive layer structure 160 may include the entire substrate 115 which may be inherently conductive, or may have been modified to be conductive so long as a permanently electrically conductive path interconnects each of the plurality of nozzle channels 20 to each other.

Conductive layer structure 160 may be a p-type layer through the use of a p-type dopant such as boron, aluminum or gallium. Alternately, conductive layer structure 160 may be an n-type layer through the use of an n-type dopant such as phosphorous, antimony, or arsenic.

Common electrohydrodynamic stimulation electrode 100 also includes at least one electrically insulating portion that is operable to electrically isolate each fluid jet 22 from a corresponding nozzle channel 20. In the example embodiment of the invention shown in FIG. 4, contiguous conductive layer structure 160 is covered by an insulating layer structure 170, such as silicon dioxide (SiO₂). Optionally, substantially all the surfaces of substrate 115 also are covered by the insulating layer structure 170. Insulating layer structure 170 may include one or more layers made from any appropriate materials with suitable insulating characteristics. As shown in FIG. 4, insulating layer structure 170 substantially covers conductive layer structure 160 as well as the inner surfaces of all the nozzle channels 20 and reservoir 118. Silicon may be thermally oxidized to produce silicon dioxide (SiO₂), which acts as a suitable insulator that covers all the features etched and not etched in a silicon substrate. Furthermore, a silicon dioxide layer is very uniform in thickness since it is formed from the silicon substrate itself when the substrate is heated in an oxygen atmosphere. When insulating layer structure 170 is made from silicon dioxide (SiO₂), insulating layer structure 170 passivates the features (including the nozzle channels and reservoir) of the print head to protect them from any corrosive effects that may arise from contact with fluids such as inks and cleaners that may be used during the operation of print head 56. SiO₂ has an electrical breakdown strength as high as 1 kV per micron of thickness. When used in the production of insulating layer structure 170, SiO₂ need not be very thick to insulate conductive layer structure 160 from a conductive donor fluid 62. Insulating layer structure 170 can electrically isolate each of the jets 22 from each of the corresponding nozzle channels 20. Insulating layer structure 170 can prevent field collapse, excessive current draw and resistive heating of jetted donor fluid 62 when jets 22 are stimulated to produce corresponding drops 150.

Referring again to FIGS. 3 and 4, an opening is formed in insulating layer structure 170, exposing conductive layer structure 160 to produce electrical contact 180. Electrical contact 180 is electrically connected to a stimulation signal driver 200 that produces a potential waveform of chosen voltage amplitude, period and functional relationship with respect to time in accordance with drop stimulation signal 210. A non-limiting example of a drop stimulation signal 210 includes a single uni-polar square wave with a 50% duty cycle. Under the influence of the single drop stimulation signal 210, contiguous conductive layer structure 160 and insulating layer structure 170 will act as a common electrohydrodynamic (EHD) stimulation electrode I 00 that will synchronously stimulate the entire plurality of fluid jets 22 emitted by the corresponding plurality of nozzle channels 20. As shown in FIGS. 3 and 4, nozzle plate 113 and the common electrohydrodynamic drop stimulation electrode 100 both include contiguous conductive layer structure 160 in an integrated assembly. Substrate 115 may be held at a fixed potential. The fixed potential can include ground if substrate 115 is electrically isolated from conductive layer structure 160. A p/n junction, an insulating layer or any other suitable means, may be used to establish electrical isolation between substrate 115 and conductive layer structure 160.

As shown in FIGS. 3 and 4, conductive layer structure 160 and insulating layer structure 170 form a common EHD drop stimulation electrode 100 that simultaneously stimulates all of the fluid jets 22 emitted from all of the nozzle channels 20. Inherently, the drop stimulation electrode is self-centered with respect to each of the nozzles channels 20. Conventional multijet systems have employed EHD electrodes consisting typically of a separate annular electrode positioned at the base (or at a downstream position near the base) of each fluid jet. The use of separate annular electrodes may lead to variations in a spacing or gap between the electrode inner diameters and their corresponding nozzle exit orifices. Electrode to jet gap variations typically lead to undesired variations with respect to the resulting stimulation of the corresponding jets. These limitations are not present in embodiments of the present invention since the common drop stimulation electrode 100 forms a part of each of the plurality of exit orifices 21. Further, the contiguous conductive layer structure 160 according to an embodiment of the present invention is uniformly spaced from each of the fluid jets 22 by a gap equal to the thickness of insulating layer structure 170 that is especially uniform when insulating layer structure 170 comprises silicon dioxide. This allows the construction of a multi-nozzle array with a very uniform nozzle-to-nozzle stimulation level so that all jets 22 break off into corresponding drop streams at the same time.

Print head surface 140 of the common EHD electrode 100 may also act as a reference surface for the plurality of fluid jets 22 emitted from the corresponding plurality of nozzle channels 20. Each jet 22 is inherently stimulated at the same point along its length (i.e. surface 140 being typically planar), thus further assuring substantially equal stimulation across all the jets 22 and substantially equal break-off lengths among all the jets.

The electrohydrodynamic stimulation of a given jet 22 is proportional to the field strength squared acting on a surface of the jet located proximate to a corresponding exit orifice 21. In embodiments of the present invention, the stimulation of any given jet 22 is typically local with respect to that jet. A local portion of common electrohydrodynamic stimulation electrode 100 typically stimulates each jet 22. This local portion typically extends approximately 20 to 25 microns around each corresponding exit orifice 21. Donor fluid 62 should be sufficiently conductive to allow charge to move through the fluid from grounded reservoir 118 during the formation of drops 150. When the thickness of insulating layer structure 170 is of the order of approximately one micron, a stimulation created by the common electrohydrodynamic stimulation electrode 100 is typically strong enough to provide stable drops with an excitation voltage on the order of 100 V.

In diffused or implanted doped semiconductor materials like silicon, resistivity is typically a function of a depth or thickness of the material. It may be convenient to consider a parameter referred to as “sheet resistance” (Rₛ) when working with doped materials like silicon. For relatively thin films such as silicon wafers, sheet resistance can be directly measured. The sheet resistance Rₛ of a material may be expressed as:
Rₛₕ=ρ/t, where
ρ is an effective, average resistivity of the material (a measure indicating how strongly the material opposes the flow of electric current), and
t is a thickness of the material.

Strictly speaking, the unit for sheet resistance is the ohm (Ω). To avoid confusion between resistance and sheet resistance, sheet resistance is typically specified in units of ohms per square (Ω/□). Sheet resistance may be measured with a four-point probe. A correction factor may be required to convert a voltage/current ratio measured by the four-point probe into a sheet resistance value. This correction typically accounts for the sample size, shape and probe spacings.

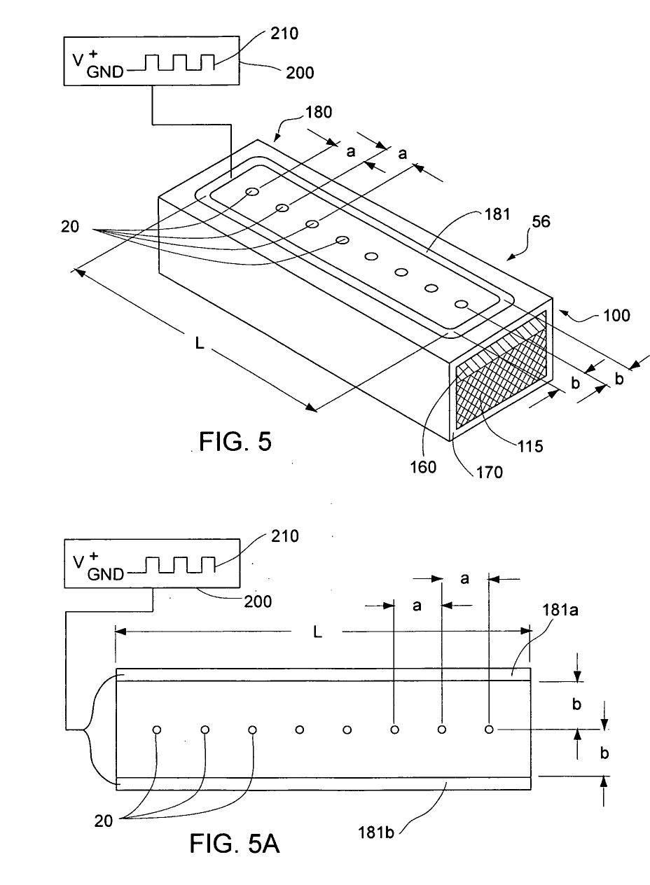

If contiguous conductive layer structure 160 is not sufficiently conductive, its sheet resistance may have a bearing on the ability to synchronously stimulate an entire plurality of fluid jets as per embodiments of the present invention. The number of fluid jets 22 emitted as well as a configuration and position of electrical contact 180 will typically have a bearing on the ability to synchronously stimulate an entire plurality of fluid jets 22. FIG. 5 shows a partial sectional view of print head 56 as per an example embodiment of the invention. As shown in FIG.5, electrical contact 180 includes a conductive annulus 181 formed around a row of nozzle channels 20. Conductive annulus 181 may be formed on conductive layer structure 160 through a corresponding opening in insulating layer structure 170. Conductive annulus 181 is preferably significantly more conductive than conductive layer structure 160. Conductive annulus 181 may be made from a highly conductive material that can include but is not limited to gold, silver, aluminum, or copper. In some embodiments of the present invention, one or more conductive annuluses may encircle one or more groups of nozzle channels of a multi-jet print head. Multi-jet print heads typically include “n” nozzle channels, where n=8 in the non-limiting embodiment of the invention shown in FIG. 5. In this embodiment of the invention each of the n nozzle channels is substantially equidistant from elongated portions of the conductive annulus 181. An approximate maximum sheet resistance for the embodiment of the invention shown in FIG. 5 may be estimated with reference to FIG. 5A. FIG. 5A represents a simplified model of the embodiment of the invention shown in FIG. 5. FIG. 5A models conductive annulus 181 with two conductive strips 181 a and 181b. Conductive strips 181a and 181b correspond to the longer sections of conductive annulus 181. Conductive strips 181a and 181b are each L long and are each separated from the row of nozzle channels 20 by a distance, b. Each nozzle channel 20 is separated from an adjacent nozzle channel by an inter-nozzle spacing, a. During the application of the potential waveform to conductive annulus 181, a capacitance is generated between conductive layer structure 160 and the fluid 62 in reservoir 118. To simplify the capacitance calculations, the half width of reservoir 118 is taken to equal distance, b. A capacitance, C of a portion of common electrohydrodynamic stimulation electrode 100 corresponding to a single nozzle channel may be estimated from the following relationship:
C=(εₒεᵢₙₛ a 2b)/tᵢₙₛ, wherein:
εₒ is a permittivity of free space,
εᵢₙₛ is a permittivity ratio (as compared with free space) of insulating layer structure 170,
tᵢₙₛ is a thickness of insulating layer structure 170, and
variables a and b are as previously defined.

The above relationship assumes that donor fluid 62 in reservoir 118 is isolated from conductive layer structure 160, to create the capacitance. This isolation may be provided by applying insulating layer structure 170, or any suitable insulator to the surfaces of reservoir 118. Additionally, the above relationship assumes that substrate 115 is also partially conductive and is not isolated from conductive layer structure 160. This situation would typically occur if conductive layer structure 160 is formed by implantation or diffusion of dopants into a semi-conducting substrate 115.

A resistance, R of a portion of common electrohydrodynamic stimulation electrode 100 corresponding to a single nozzle channel may be estimated from the following relationship:
R=(Rₛₕb/a)/2, wherein:
Rₛₕ is a sheet resistance of conductive layer structure 160, and
variables a and b are as previously defined.

In order for all of the nozzle channels 20 to be substantially stimulated with the same stimulation intensity and phase, the capacitance of the common electrohydrodynamic stimulation electrode 100 must be charged sufficiently quickly enough through the resistance of the electrode. The charging RC time constant, T of common electrohydrodynamic stimulation electrode 100 may be estimated from the following relationship:
T=RC=(b²Rₛₕεₒεᵢₙₛ)/tᵢₙₛ.

To ensure that sufficiently fast charging, the charging time constant T<<1/f, where variable, f is a stimulation frequency associated with the rate of drop formation created from the stimulation of fluid jets 22 under the influence of the at least one potential waveform created by stimulation signal driver 200. Preferably, T≦(1/10f). Accordingly, the required sheet resistance of conductive layer structure 160 may be estimated from the following relationship:
Rₛₕ≦(tᵢₙ/10 f)/(b²εₒε^{ins}).

A required sheet resistance of an exemplary embodiment of the invention employing a stimulation frequency, f=10⁶ Hz; an insulating layer thickness, tᵢₙₛ=10⁻⁶ m, an electrical contact-to-nozzle spacing, b=200*10⁻⁶, a permittivity of free space, εₒ=8.85×10⁻¹² C²/Nm² , and a permittivity ratio of SiO₂, εᵢₙₛ=3.9 may be estimated to be Rₛₕ≦100,000 Ω/□.

Again referring to FIG. 5, it will be readily apparent to those skilled in the art in light of the above relationships, that a distance between each nozzle channel 20 and conductive annulus 181 may be determined in accordance with a given sheet resistance of a particular conductive layer structure 160 that is to be employed. It will be readily apparent that this distance may be further determined by various other systems parameters that include, but are not limited to a stimulation frequency, f and a thickness, tᵢₙₛ of insulating layer structure 170 that are to be employed.

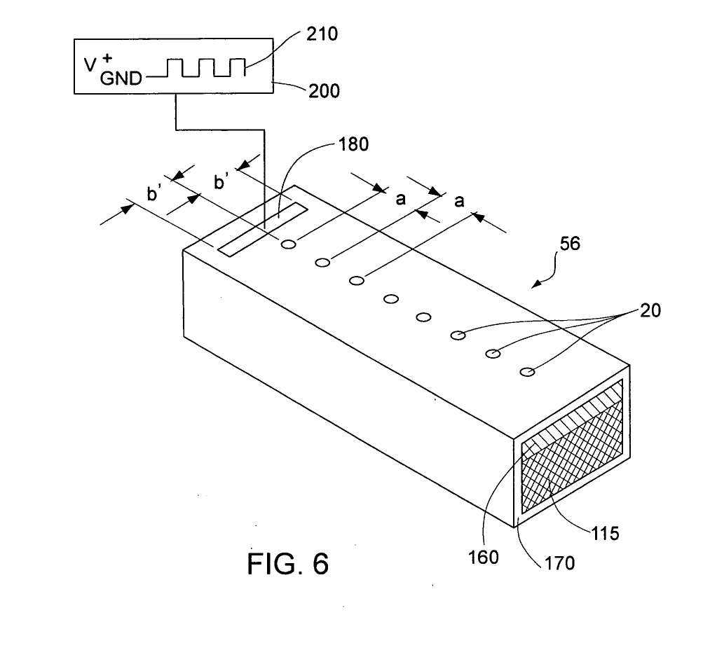

FIG. 6 shows a partial sectional view of print head 56 as per another example embodiment of the invention. In this embodiment of the invention, electrical contact 180 is positioned at one end of print head 56. Print head 56 includes a row of nozzle channels 20. Electrical contact 180 may be formed on conductive layer structure 160 through a corresponding opening in insulating layer structure 170. Print head 56 includes “n” nozzle channels, where n=8 in this non-limiting embodiment of the invention. In this embodiment of the invention each of the n nozzle channels are positioned at progressively increasing distances from electrical contact 180. An approximate maximum sheet resistance for the embodiment of the invention shown in FIG.6 may be estimated in a similar fashion as previously disclosed. As shown in FIG. 6, electrical contact 180 is separated from each of the nozzle channels 20 by a linear multiple of inter-nozzle spacing, a. A capacitance, C (per nozzle channel) created during the charging of the common electrohydrodynamic stimulation electrode 100 may be estimated from the following relationship:
C=(εₒεᵢₙₛa 2b′)/tᵢₙₛ, where:
b′ is the half width of electrical contact 180, and
variables εₒ, εᵢₙₛ a and tᵢₙₛ are as previously defined.

For the sake of simplicity, the above capacitance relationships assumes that the half width of reservoir 118 is equal to distance, b′. Again, the above relationship assumes that donor fluid 62 in reservoir 118 is isolated from conductive layer structure 160; to create the capacitance. This isolation may be provided by applying insulating layer structure 170, or any suitable insulator to the surfaces of reservoir 118.

A resistance of various portions of conductive layer structure 160 will typically vary with the distance between each of the nozzle channels 20 and electrical contact 180. An approximate maximum resistance of the common electrohydrodynamic stimulation electrode will be typically associated with the nozzle channel that is furthest away from electrical contact 180 (i.e. the n'th nozzle channel). This approximate maximum resistance, R may be estimated from the following relationship:
R=(Rₛₕ)(n a)/2b′ wherein:
n is a total number of nozzle channels 20 in the array,
Rₛₕ is a sheet resistance of conductive layer 160, and
variables a and b′ are as previously defined.

The charging time constant, T for all the nozzles channels in the array based on the approximate maximum resistance, R may be estimated from the following relationship:
T=RC=(n a²Rₛₕεₒεᵢₙₛ)/tᵢₙₛ

As previously described, the charging RC time constant T<<1/f, and T≦(1/10 f) may be used. Accordingly, a required sheet resistance of conductive layer structure 160 shown in FIG. 6 may be estimated by the following equation:
Rₛₕ≦(tᵢₙₛ/10 f)/(n a²εₒεᵢₙₛ).

A required sheet resistance for an exemplary common electrohydrodynamic stimulation electrode 100 which is configured similarly to the embodiment shown in FIG. 6, and which includes a total number of nozzle channels, n=400, a stimulation frequency, f=10⁶ Hz; an insulating layer thickness, tᵢₙₛ=10⁻⁶ m, an inter-nozzle spacing, a=85×10⁻⁶, a permittivity of free space, εₒ=8.85×10⁻¹² C²/Nm² , and a relative permittivity ratio of SiO₂, εᵢₙₛ=3.9 may be estimated to be Rₛₕ<1000 Ω/□.

A required sheet resistance for some embodiments of the present invention may vary with various print head 56 configurations. The total number of nozzle channels 20, the arrangement of the nozzle channels 20 into one or more rows or groups, the number and configuration of electrical contacts 180 as well as its their position with respect to each of the nozzle channels 20 are some of the factors that may have a bearing on the ability of common stimulation drop electrode 100 to synchronously stimulate the plurality of nozzle channels. Again, it will be readily apparent to those skilled in the art the arrangement of nozzle channels and in particular, the distance between each nozzle channel and the electrical contact 180 may be determined in accordance with a given sheet resistance of a particular conductive layer structure 160 that is to be employed. It will be readily apparent that this distance may be further determined by various other systems parameters that include, but are not limited to a stimulation frequency, f and a thickness, tᵢₙₛ of insulating layer structure 170 that are to be employed.

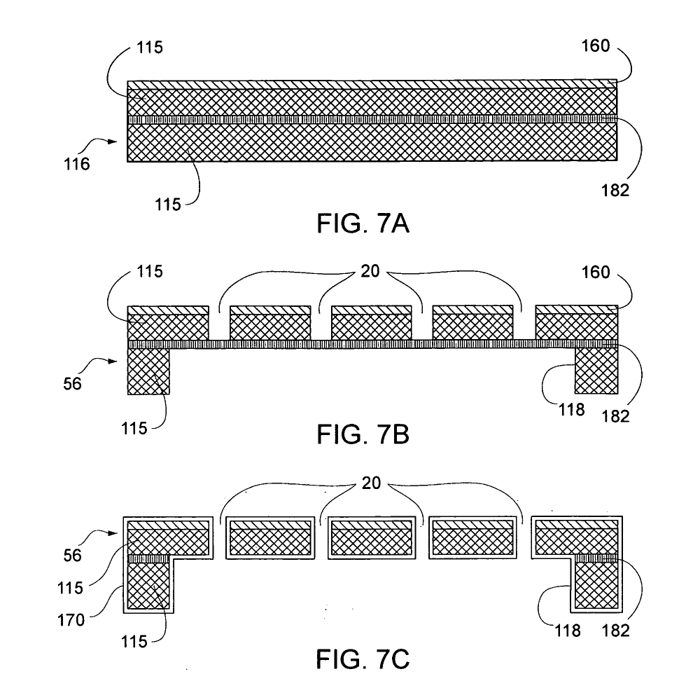

Print head 56 may be produced by a number of suitable micro-machining and semiconductor fabrication techniques. Although DRIE is a preferred method of producing nozzle channels 20, other suitable methods of construction are not precluded in the practice of the present invention. Further, DRIE and other micromachining methods such as anisotropic wet etching may be used to produce other print head structures such a reservoir 118. Standard semi-conductor techniques may also be employed to create electrical pathways to electrical contact 180 and various ground points. Electrical leads may then attached to the electrical pathways by a means such as wire bonding. A print head 56 according to one embodiment of the invention may be produced from the sequence of steps shown in shown in FIGS. 7A, 7B, and 7C. Print head 56 may be produced from a silicon-on-insulator (SOI) wafer 116 as shown in FIG. 7A. SOI wafers typically comprise pre-manufactured assemblages of various semiconductor substrates, insulating layers and stop layers. As shown in FIG. 7A, SOI wafer 116 includes substrates 115 (e.g., silicon), a conductive layer structure 160 and a buried stop layer 182. Alternatively, conductive layer structure 160 may be absent in SOI wafer 116, and a substrate 115 may be appropriately doped to provide the necessary functional characteristics of layer structure 160 required by embodiments of the present invention. Buried stop layer 182 may include silicon dioxide or any other suitable material that can stop, or alter the etch rate of an etching process used to incorporate features in the neighboring substrate 115. Stop layers may be employed to stop an etching process at predetermined depths within a substrate. As shown in FIG. 7B, etching the back of SOI wafer 116 to buried stop layer 182 using a DRIE process can produce reservoir 118. Alternatively, reservoir 118 can also be formed with a wet etching process. A plurality of nozzle channels 20 can be formed by DRIE etching down to the buried stop layer 182 from the front of SOI wafer 116. As shown in FIG. 7C, buried stop layer 182 can be removed from at least a portion of reservoir 118 with either a wet or dry etch to establish fluid communication between reservoir 118 and the plurality of nozzle channels 20. Insulating layer 170 may then be formed over the surfaces of the entire structure by thermally oxidizing SOI wafer 116.

Since an electrohydrodynamic stimulation electrode is typically covered with an insulating layer it has been experimentally determined that it does not matter if the electrode is stimulated by a drop stimulation signal that creates a regular bipolar potential waveform or a uni-polar potential waveform (i.e. with an added DC voltage shift of the same size as the amplitude). Drops are typically created from the jet at a stimulation frequency, f that is twice the driver frequency associated with the voltage waveform in both scenarios. This may occur because the overall DC level is cancelled by a development of a surface charge on the outside surface of the insulating layer such that the two cases are equivalent from the perspective of the jets. The stimulation typically depends on the square of the applied potential created by the stimulation signal, so both negative and positive half cycles of the potential waveform act on the jet to produce a drop.

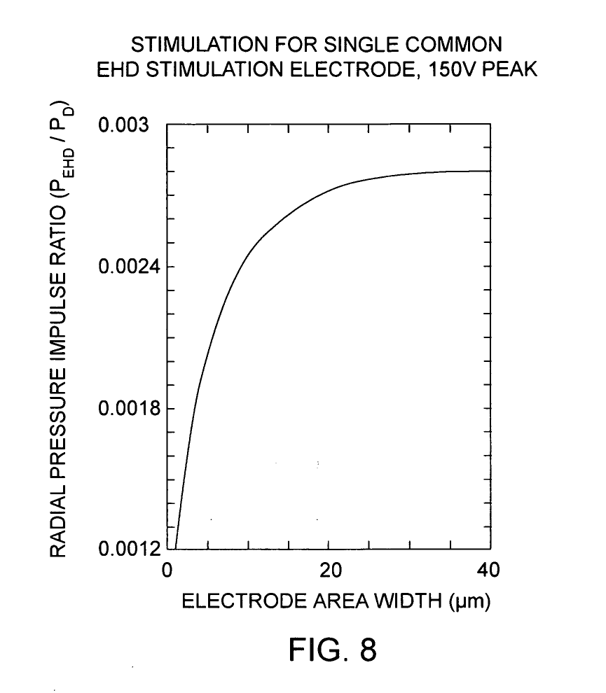

As previously described, each of the plurality of nozzle channels 20 are stimulated by a local portion of a common EHD drop stimulation electrode 100 of the present invention. FIG. 8 shows a graph that simulates the changes in the radial electrohydrodynamic impulse ratio (P_{EHD}/P₀) as a function of the width of a portion of an area of a common stimulation electrode surrounding a given exit orifice 21. P_{EHD} refers to a resulting EHD pressure and P₀ refers to atmospheric pressure. As indicated in the graph, the common EHD drop stimulation electrode 100 is driven by a stimulation waveform with a 150 V peak. Essentially, for any given stimulated jet, the majority of the stimulation of the given jet is created by a portion of the common electrode approximately 20 to 25 microns in width around a corresponding nozzle exit orifice 21. The remaining portions of the common stimulation electrode do not significantly contribute to stimulation of the given jet, but may induce a partial charge on drop 150 as it breaks-off. This effect may occur if a drop 150 is not sufficiently shielded from the common EHD stimulation electrode during break-off. Since drops are typically emitted from both the positive and negative half cycles of the stimulation signal waveform, a parasitic induced charge may be imparted onto the resulting stream of drops. The parasitic induced charge is typically of opposite sign on every other drop. This effect can be referred to as inductive A/B charging. Several potential undesired effects may arise from inductive A/B charging. Print drop misplacement may arise as every other print drop may be deflected to some degree in opposite directions as the drops travel through the deflection plates towards a receiver surface. It may also be increasingly more difficult to gutter non-printing drops since every other non-printing drop may have less than a desired charge required for accurate guttering.

By referring back to FIG. 4, another mechanism that can cause a second form of A/B charging will be described. The second mechanism may be created by a large capacitance created between contiguous conductive layer structure 160 and the conductive fluid 62 in reservoir 118. Contiguous conductive layer structure 160 is typically separated from conductive donor fluid 62 by insulating layer 170 (or any other suitable insulator) that covers a respective surface area of reservoir 118. As the potential waveform is applied to common EHD stimulation electrode 100, this capacitance must be charged and discharged with the current on the reservoir side flowing through the conductive donor fluid 62 to a nearest, better conducting ground. Depending on the geometry and materials of the reservoir 118, the conductivity level of donor fluid 62 may not be sufficient to prevent a sizeable voltage drop from appearing across donor fluid 62 even if the peak stimulation amplitude is not significantly affected. A potential arises in the vicinity of surface 140. This potential is alternatively at a positive value, then a negative value relative to ground. This variance in polarity may cause alternate drops to break off with additional undesired charges of opposite polarity since the potential difference charge electrode-to jet now varies. This form of A/B charging may be referred to as resistive A/B charging.

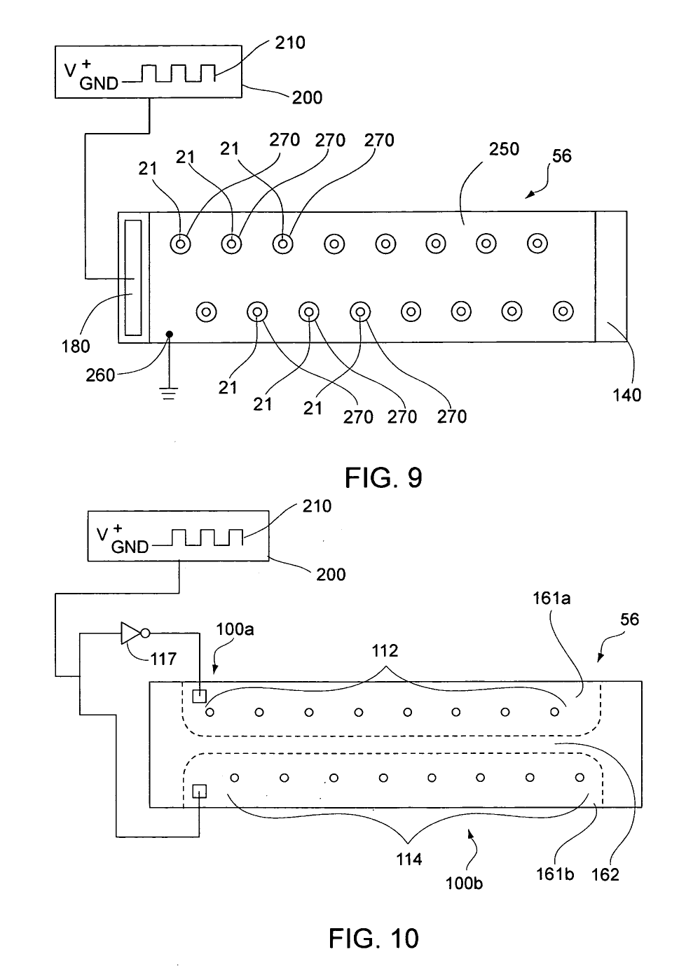

As per another example embodiment of the invention, print head 56 includes a shield portion. As shown in FIG. 9, surface 140 of print head 56 is substantially covered with a shield layer structure 250. Shield layer structure 250 is electrically conductive and may include a metal layer. In some embodiments of the present invention, shield layer structure 250 may be made from one or more layers, and/or from other suitably conductive materials. Shield layer structure 250 can be grounded at one or more ground points 260. Shield layer structure 250 may include openings 270. Each opening 270 is approximately centered about one of the plurality of nozzle channel exit orifices 21. Each of the openings 270 is sufficiently large to ensure that the EHD stimulation of the jet emitted from the corresponding exit orifice 21 is not screened out. In one embodiment of the invention, openings 270 expose portions of the underlying common EHD stimulation electrode that are at least approximately 20 to 25 microns in width around each of the exit orifices 21. Absolute concentricity of openings 270 with the corresponding exit orifices 21 is not required and small misalignments are permissible so long as the stimulation of the fluid jets is not significantly screened out. Openings 270 still leave the bulk of the surface 140 covered with a conductive shield layer structure 250 that is typically capable of reducing inductive A/B charging to negligible or manageable levels. An additional protective layer (not shown) may include, but is not limited to, a CVD oxide or nitride layer, may be formed on shield layer 250 to protect it from electrochemical effects yet still provide inductive A/B charging suppression. An additional protective layer may, or may not, also be created in the portions of the surface 140 that are exposed by openings 270.

Another example embodiment of the present invention is shown in FIG. 10. In this embodiment, print head 56 includes two separate groups, or rows of nozzles channels 112 and 114. Implantation or diffusion of two regions 161a and 161b of a semi-conductor type substrate to form diodes creates a plurality of separate common electrodydrodynamic stimulation electrodes 100. Regions 161a and 161b may comprise substantially similar areas. This embodiment of the invention is especially favorable if the print head 56 includes two rows of nozzles, in which case, a first common EHD stimulation electrode 100a is created along a first row, while a second common EHD stimulation electrode 100b is created along a second row. It is understood that one of the two implanted or diffused regions need not contain any nozzles if only a single row of nozzle channels is desired. A substrate region 162 located between the rows may be doped to form a p-n junction capable of withstanding a maximum voltage difference between the two common electrohydrodynamic stimulation electrodes 100a and 100b. It is understood that the stimulation levels obtainable by electrodes 100a and 100b will typically be limited by the p-n junction break-down strength. Each group of jets emitted from a corresponding row of nozzle channels can be stimulated out of phase from one another by employing an optional inverter 117 that can invert a single potential waveform created by drop stimulation driver 200. The two common EHD stimulation electrodes 100a and 100b may be driven 180 degrees out of phase with respect to one another so that when the first row stimulates its corresponding jets on the negative half cycle, the second row stimulates its corresponding row of jets on the positive half cycle. In this respect common EHD electrode 100b is driven in response to a single potential waveform while single common EHD electrode 100a is driven in response to the inversion of the potential waveform. Provided that an inter-row spacing is considerably less that the jet break-off length, and that the areas of the two common EHD stimulation electrodes 100a and 100b are substantially similar, any induced charge at drop break-off may be largely cancelled to leave only negligible inductive A/B charging. In this example embodiment of the invention, both common EHD stimulation electrodes 100a and 100b may be driven in accordance with a uni-polar potential waveform to maintain isolation. Any DC component of such uni-polar potential waveforms are typically cancelled by any developed surface charge. As in some embodiments of the invention, at least each of the implanted regions 161a and 161b, as well as their associated nozzle channels are typically covered with an insulating layer structure 170.

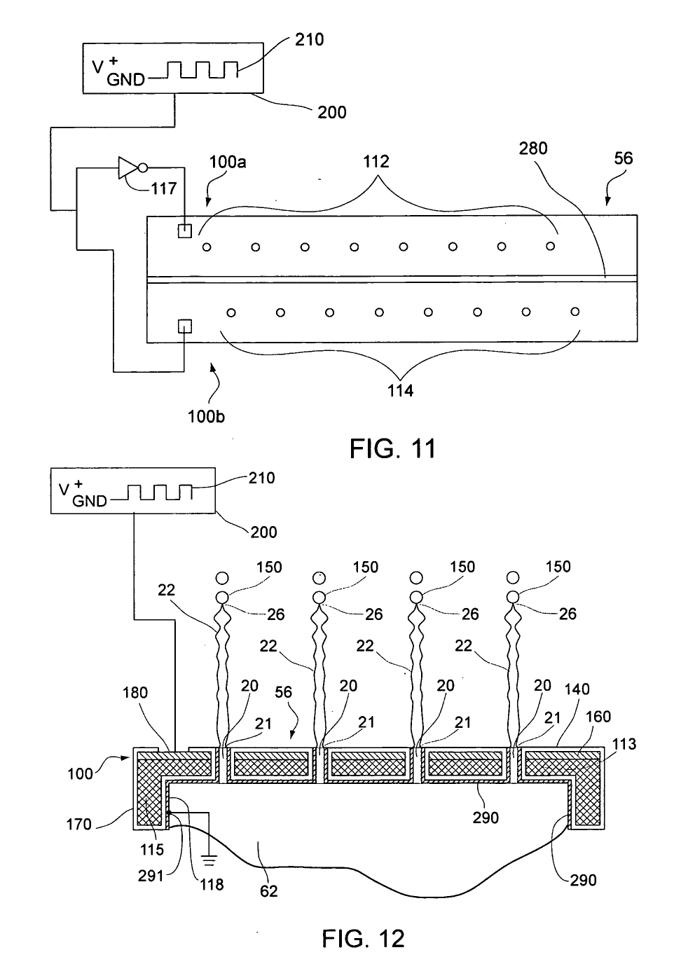

Another example embodiment of the invention that can be used to suppress inductive A/B charging effects is schematically shown in FIG. 11. In this embodiment, separate first and second common electrohydrodynamic stimulation electrodes 100a and 100b are created by etching a trench 280 between the two rows of nozzles 112 and 114 down to a buried stop-layer (not shown) in order to separate the top active layer into two separate electrodes which may be driven out of phase with respect to one another as described in the embodiment of the present invention shown in FIG. 10. The top active layer may include a contiguous conductive layer structure 160 covered by an insulating layer structure 170 (both layer structures not shown in FIG. 11). A buried stop layer 182 (also not shown) may be positioned between the contiguous conductive layer structure 160 and an underlying substrate.

FIG. 12 shows a cross-sectional view of yet another example embodiment of the present invention in which resistive A/B charging effects may be reduced or substantially eliminated by at least covering reservoir 118 with a fixed potential layer structure 290. Fixed potential layer structure 290 is highly conductive and may include a metal material such as gold. Fixed potential layer structure 290 may be made from one or more layers, and/or from other suitably conductive materials. Fixed potential layer structure 290 is held at a fixed potential, e.g., ground. A ground potential may be achieved with one or more ground points 291. In this embodiment, fixed potential layer structure 290 typically provides a lower resistance path to ground as compared with the donor fluid 62, and thus reduces resistive A/B charging to a negligible amount. Fixed potential layer structure 290 can also be applied to an inner surface of each of the nozzle channels 20. Applying fixed potential layer structure 290 to inner surfaces of each of the nozzle channels 20 can also reduce any resistive A/B charging arising from tunnel capacitance and donor fluid 62 resistance within the nozzle channels themselves. Fixed potential layer structure 290 can reduce or substantially eliminate resistive A/B charging by providing an alternate lower resistance path than donor fluid 62.

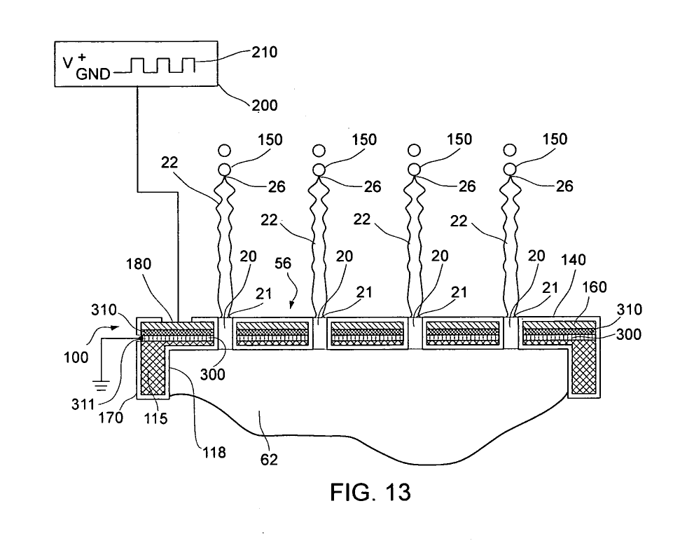

FIG. 13 shows a cross-sectional view of yet another example embodiment of the present invention in which resistive A/B charging effects may be reduced or substantially eliminated when the print-head additionally includes at least one conductive portion and at least one insulator portion. Print head 56 includes common electrohydrodynamic stimulation electrode 100 that includes contiguous conductive layer structure 160 and insulating layer structure 170. Print head 56 includes at least one conductive layer 300 that may be made from a same material used in contiguous conductive layer structure 160, or other suitably conductive material. The at least one conductive layer 300 can be substrate material 115. The at least one conductive layer 300 is electrically isolated from contiguous conductive layer structure 160 by at least one insulator layer 310 which is positioned between the two. At least one conductive layer 300 is held at a fixed potential. At least one conductive layer 300 can be grounded by ground point 311. During the application of a drop stimulation signal 210, capacitance is created between at least one conductive layer 300 and contiguous conductive layer structure 160. Typically, no current arising from this capacitance flows through the conductive donor fluid 62 since both the donor fluid 62 and at least one conductive layer 300 are at the same potential. The at least one insulator layer 310 may be, but is not limited to, another layer of oxide as provided on a double SOI wafer or a depletion layer created by a reversed biased junction. In this embodiment of the invention, resistive A/B charging may be eliminated or minimized since a capacitance arising from the common electrohydrodynamic stimulation electrode and donor fluid 62 in reservoir 118 can be reduced to very low levels.

In embodiments of the invention in which two separate common electrohydrodynamic stimulation electrodes are driven 180 degrees out of phase with respect to each other to reduce inductive A/B charging may also be used to reduce resistive A/B charging even if both electrodes are strongly capacitively coupled to reservoir 118. In these embodiments, current established in the fluid during the charging of any one of the two electrodes will typically not flow to a potentially distant ground. Rather, current will flow typically to the nearby opposite polarity electrode which due to its proximity forms a low resistance path, thereby resulting in a small corresponding voltage drop.

In the context wherein state of the art MEMS fabrication techniques are employed, a common electrohydrodynamic stimulation electrode 100 may be made from any appropriate substrate that can be doped to provide the necessary properties including sheet resistance. Further, although the common electrohydrodynamic stimulation electrodes 100 have been described as possibly being produced by state of the art MEMS fabrication techniques, this is not to be considered a limitation. As such, additional embodiments of the invention may comprise common electrohydrodynamic stimulation electrodes 100 produced from any appropriate materials using any appropriate fabrication techniques known in the art.

According to some embodiments of the present invention, a plurality of nozzle channels may be grouped into subsets of nozzle channels. Each of the subsets of nozzle channels may be made up of a plurality of nozzle channels and each subset may be stimulated with a corresponding common electrohydrodynamic stimulation electrode 100 as defined in embodiments of the present invention. Embodiments of the present invention may be used in multi-jet and multi-row continuous inkjet printers.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

10 fluid supply
12 fluid
13 conventional droplet stimulation electrode
17 conventional stimulation signal driver
19 stimulation signal
20 nozzle channel
21 exit orifice
22 fluid jet
24 insulating layers
26 break-off point
30 charge electrode
32 charge electrode driver
33 charging signal
34 charged drops
36 uncharged drops
38 electrostatic deflection plates
40 gutter
42 receiver surface
50 printing apparatus
52 housing
54 interior chamber
56 print head
58 translation unit
60 system controller
62 donor fluid
64 source of pressurized donor fluid
65 first direction
66 droplet generation circuit
70 stream of drops
74 droplet separation means
76 motor
78 rollers
100 common electrohydrodynamic drop stimulation electrode
100a first common EHD drop stimulation electrode
100b second common EHD drop stimulation electrode
112 row of nozzle channels
114 row of nozzle channels
113 nozzle plate
115 substrate
116 silicon-on-insulator wafer
117 inverter
118 reservoir
140 print head surface
150 drop
160 contiguous conductive layer structure
161a region
161b region
162 region
170 insulating layer structure
180 electrical contact
181 conductive annulus
181a conductive strip
181b conductive strip
182 buried stop layer
200 stimulation signal driver
210 stimulation signal
250 shield layer structure
260 ground point
270 opening
280 trench
290 fixed potential layer structure
291 ground point
300 at least one conductive layer
310 insulator layer
311 ground point

1. An apparatus for forming a first plurality of drop streams, the apparatus comprising:
a) a first plurality of nozzle channels operable to emit a first plurality of fluid jets, and
b) a first common electrohydrodynamic stimulation electrode operable to form the first plurality of drop streams by synchronously stimulating all members of the first plurality of fluid jets in response to an electrical signal,
wherein the first common electrohydrodynamic stimulation electrode comprises a first contiguous electrically conductive portion that forms at least a portion of each member of the first plurality of nozzle channels, and
wherein the first common electrohydrodynamic stimulation electrode further comprises an electrical contact operable to transmit the electrical signal to each member of the first plurality of nozzle channels via the first contiguous electrically conductive portion.

2. The apparatus of claim 1, wherein the first contiguous electrically conductive portion forms a permanently electrically conductive path between each member of the first plurality of nozzle channels.

3. The apparatus of claim 1, wherein each member of the first plurality of fluid jets is synchronously stimulated by the electrical signal with a common stimulation frequency, and wherein the first common electrohydrodynamic stimulation electrode comprises an RC time constant less than, or equal to about one tenth of the common stimulation frequency.

4. The apparatus of claim 1, wherein a sheet resistance of the first contiguous electrically conductive portion is less than about 100,000 Ω/□.

5. The apparatus of Claim I, wherein the first common electrohydrodynamic stimulation electrode comprises at least one electrically insulating portion, the at least one electrically insulating portion operable to electrically isolate each of the plurality of fluid jets from the contiguous electrically conductive portion.

6. The apparatus of claim 5, wherein the at least one electrically insulating portion covers a bore surface of each nozzle channel.

7. The apparatus of claim 1, wherein the first contiguous electrically conductive portion is positioned proximate to an exit orifice of each nozzle channel.

8. The apparatus of claim 1, wherein each member of the first plurality of nozzle channels comprises an exit orifice, each of the exit orifices comprising an area, and wherein each of the areas is within about ±0.5% of each other.

9. The apparatus of claim 1, further comprising:
a) a reservoir operable to supply conductive fluid to the first plurality of nozzle channels, and
b) a fixed potential layer structure located on at least one surface of the reservoir, wherein the fixed potential layer structure is electrically conductive and is operable to hold the conductive fluid at a fixed potential.

10. The apparatus of claim 1, wherein the first common electrohydrodynamic stimulation electrode comprises at least one electrically insulating portion, the at least one electrically insulating portion being disposed on a surface of the first contiguous electrically conductive portion, and wherein the electrical contact comprises an opening in the at least one electrically insulating portion, the opening exposing a portion of the first contiguous electrically conductive portion.

11. The apparatus of claim 1, wherein the electrical contact comprises a conductive annulus positioned around the first plurality of nozzle channels.

12. The apparatus of claim 1, wherein at least one member of the first plurality of nozzle channels is positioned from the electrical contact by a different distance than an additional member of the first plurality of nozzle channels.

13. The apparatus of claim 1, further comprising:
a) at least one electrically insulating portion disposed on a surface of the first contiguous electrically conductive portion, and
b) a shield portion disposed on a surface of the at least one electrically insulating portion, wherein the shield portion includes:
i) a conductive material, and
ii) a plurality of openings, each of the plurality of openings corresponding to one or more members of the first plurality of nozzle channels.

14. The apparatus of claim 1, further comprising:
a) at least one conductive portion separate from the first contiguous electrically conductive portion, the at least one conductive portion being held at a fixed potential, and
b) at least one insulator portion disposed between the at least one conductive portion and the first contiguous electrically conductive portion, wherein the at least one insulator portion is operable to electrically isolate the at least one conductive portion from the first contiguous electrically conductive portion.

15. The apparatus of claim 14, wherein the fixed potential is ground.

16. The apparatus of claim 1, wherein the apparatus is operable to form a second plurality of drop streams by synchronously stimulating a corresponding second plurality of fluid jets, the apparatus comprising:
a) a second plurality of nozzle channels operable to emit the second plurality of fluid jets, and
b) a second common electrohydrodynamic stimulation electrode operable to synchronously stimulate the second plurality of fluid jets in response to the electrical signal or a derivative thereof,
wherein the second common electrohydrodynamic stimulation electrode comprises a second contiguous electrically conductive portion, and
wherein the second contiguous electrically conductive portion forms a permanently electrically conductive path between each member of the second plurality of nozzle channels.

17. The apparatus of claim 16, wherein the second contiguous electrically conductive portion forms at least a portion of each member of the second plurality of nozzle channels.

18. The apparatus of claim 16, further comprising a p-n junction formed between the first and second contiguous electrically conductive portions, wherein the p-n junction is operable to electrically isolate the first common electrohydrodynamic stimulation electrode from the second common electrohydrodynamic stimulation electrode.

19. The apparatus of claim 16, further comprising a trench formed between the first and second contiguous electrically conductive portions, wherein the trench is operable to electrically isolate the first common electrohydrodynamic stimulation electrode from the second common electrohydrodynamic stimulation electrode.

20. The apparatus of claim 17, further comprising at least one electrically insulating portion operable to electrically isolate each of the first and second plurality of fluid jets from each of the corresponding first and second contiguous electrically conductive portions.

21. The apparatus of claim 16, further comprising an inverter operable to invert the electrical signal, wherein the second common electrohydrodynamic stimulation electrode is operable to synchronously stimulate the second plurality of fluid jets in response to a potential waveform of the inverted electrical signal, and wherein the inverted electrical signal is the derivative of the electrical signal.

22. The apparatus of claim 1, wherein the apparatus is a multi-row continuous ink-jet apparatus.

23. The apparatus of claim 1, wherein the first contiguous electrically conductive portion comprises at least one of an n-type doped silicon and a p-type doped silicon.

24. The apparatus of claim 1, wherein the first contiguous electrically conductive portion comprises a contiguous conductive layer structure.

25. A method for forming a plurality of drop streams, the method comprising:
a) emitting a plurality of fluid jets from a corresponding plurality of nozzle channels, and
b) synchronously stimulating all members of the plurality of fluid jets by applying a potential waveform to an electrical contact of a common electrohydrodynamic stimulation electrode, the common electrohydrodynamic stimulation electrode comprising a contiguous electrically conductive portion that forms a permanently electrically conductive path between each nozzle channel in the plurality of nozzle channels, wherein a distance between each nozzle channel and the electrical contact is determined in accordance with a sheet resistance of the contiguous electrically conductive portion.

26. The method of claim 25, further comprising synchronously stimulating each member of the plurality of fluid jets with a common stimulation frequency, and wherein the distance between each nozzle channel and the electrical contact is further determined in accordance with the common stimulation frequency.

27. The method of claim 25, wherein the common electrohydrodynamic stimulation electrode comprises an electrically insulating portion operable to electrically isolate the plurality of fluid jets from the contiguous electrically conductive portion, and wherein the distance between each nozzle channel and the electrical contact is further determined in accordance with a thickness of the electrically insulating portion.
